(19) United States
(12) Patent Application Publication
(10) Pub. No.: US 2011/0153896 A1
(43) Pub. Date: Jun. 23, 2011

(54) SEMICONDUCTOR MEMORY CARD, METHOD FOR CONTROLLING THE SAME, AND SEMICONDUCTOR MEMORY SYSTEM

(75) Inventors: Yoshihito Sugiyama, Tokyo (JP); Tatsuya Kaise, Tokyo (JP); Hiroshi Endo, Tokyo (JP); Hiroko Okabayashi, Tokyo (JP); Masahiko Murohashi, Tokyo (JP)

(73) Assignee: KABUSHIKI KAISHA TOSHIBA, Minato-Ku (JP)

(21) Appl. No.: 13/039,854

(22) Filed: Mar. 3, 2011

Related U.S. Application Data
(63) Continuation of application No. 11/934,498, filed on Nov. 2, 2007, now abandoned.

(30) Foreign Application Priority Data
Nov. 2, 2006 (JP) 2006-299546

(51) Int. Cl. G06F 13/14

(52) U.S. Cl. 710/301

(57) ABSTRACT

A semiconductor memory card which can be attached to a host apparatus and can be removed from the host apparatus includes a plurality of data transfer terminals, and an internal circuit transmitting a first signal to at least one first data transfer terminal comprising at least one of the data transfer terminals and transmitting a second signal to at least one second data transfer terminal comprising at least one of the data transfer terminals different from the first data transfer terminals. The second signal is generated by executing a logical operation on the first signal.

### CROSS-REFERENCE TO RELATED APPLICATIONS

This application is a continuation application of U.S. Ser. No. 11/934,498, filed Nov. 2, 2007, which claims priority under 35 U.S.C. §119 to Japanese Patent Application No. 2006-299546, filed Nov. 2, 2006, the entire contents of which are incorporated herein by reference.

### FIELD OF THE INVENTION

The present invention relates to a semiconductor memory card, a method for controlling the same, and a semiconductor memory system.

### DESCRIPTION OF THE RELATED ART

In recent years, mass digital contents, such as high definition and high resolution mass video data like a digital terrestrial broadcast picture (a maximum transfer rate of 17 Mbps), a BS digital broadcast picture (a maximum transfer rate of 24 Mbps), or a video data that contains a lot of motion pictures, are increasing.

In order to record these video data on a semiconductor memory card, increasing a capacity of the semiconductor memory card becomes indispensable. Although the semiconductor memory card with the storage capacity of 4 GB is commercialized at present, it is thought that a further progress of increasing a capacity of the semiconductor memory card continues.

Thus, as increasing the capacity of the semiconductor memory card progresses, a method of data transfer at a high bit rate will be required by the demand for recording and reproducing high quality data as it is with using neither the MPEG4 compression technology of high compressibility, nor the technology which changes a bit rate of data transfer into a low bit rate.

However, the data transfer at a high bit rate tends to be influenced by noise, accordingly, in such a condition, the problem that it becomes impossible to transmit data correctly occurs.

On the other hand, in a cellular phone which can use a semiconductor memory card, the operating voltage is set relatively low in order to reduce power consumption due to the demand for extending battery drive time. Consequently, it becomes easily influenced by noise and the problem that it becomes impossible to transmit data correctly occurs.

With the semiconductor memory card of the conventional technology disclosed in Japanese Patent Application Laid-Open No. 2000-357126, the influence of noise by improving the speed of data transfer and lowering operating voltage is not taken into consideration.

### SUMMARY

A first aspect in accordance with the present invention provides a semiconductor memory card which can be attached to a host apparatus and can be removed from said host apparatus comprising: a plurality of data transfer terminals; and an internal circuit transmitting a first signal to first data transfer terminals comprising at least one of said data transfer terminals and transmitting a second signal to second data transfer terminals comprising at least one of said data transfer terminals different from said first data transfer terminals, wherein said second signal is generated by executing logical operation to said first signal.

A second aspect in accordance with the present invention provides a method for controlling a semiconductor memory card which includes a plurality of data transfer terminals comprising: setting either a first operation mode or a second operation mode according to a command from a host apparatus; transmitting a signal to said data transfer terminals using a first bus width more than two bits in said first operation mode; transmitting a first signal to first data transfer terminals comprising at least one of said data transfer terminals using a second bus width less than said first bus width and transmitting a second signal to second data transfer terminals comprising at least one of said data transfer terminals different from said first data transfer terminals in said second operation mode; and generating said second signal by executing a logical operation on said first signal.

A third aspect in accordance with the present invention provides a semiconductor memory system comprising: a plurality of data transfer terminals; a memory device storing data inputted from said data transfer terminals; and an internal circuit operating in a first operation mode and a second operation mode, wherein in said first operation mode, said internal circuit transmits a signal to said data transfer terminals using a first bus width more than two bits, and in said second operation mode, said internal circuit transmits a first signal to first data transfer terminals comprising at least one of said data transfer terminals using a second bus width less than said first bus width and transmits a second signal to second data transfer terminals comprising at least one of said data transfer terminals different from said first data transfer terminals, said second signal being generated by executing a logical operation on said first signal.

### BRIEF DESCRIPTION OF THE DRAWINGS

FIG. 1 illustrates a schematic view of a semiconductor memory card in accordance with an embodiment of the present invention.

FIG. 2 illustrates a block diagram of a semiconductor memory card in accordance with an embodiment of the present invention.

FIG. 3 illustrates a block diagram of a host apparatus to which a semiconductor memory card can be attached in accordance with an embodiment of the present invention.

FIG. 4 illustrates a block diagram of a data switch circuit on a semiconductor memory card in accordance with an embodiment of the present invention.

FIGS. 5(a) and 5(b) illustrate a timing diagram of a single read operation and a single write operation on a semiconductor memory card in accordance with an embodiment of the present invention.

FIGS. 6(a) and 6(b) illustrate a schematic view of a data format in a first operation mode and a second operation mode on a semiconductor memory card in accordance with an embodiment of the present invention.

FIG. 7 illustrates a waveform chart of a data bus in a second operation mode on a semiconductor memory card in accordance with an embodiment of the present invention.

FIG. 8 illustrates a flowchart of a single read operation on a semiconductor memory card in accordance with an embodiment of the present invention.

FIG. 9 illustrates a flowchart of a single write operation on a semiconductor memory card in accordance with an embodiment of the present invention.

### DETAILED DESCRIPTION OF THE EXEMPLARY EMBODIMENTS

Hereinafter, an embodiment of the present invention is explained with reference to drawings.

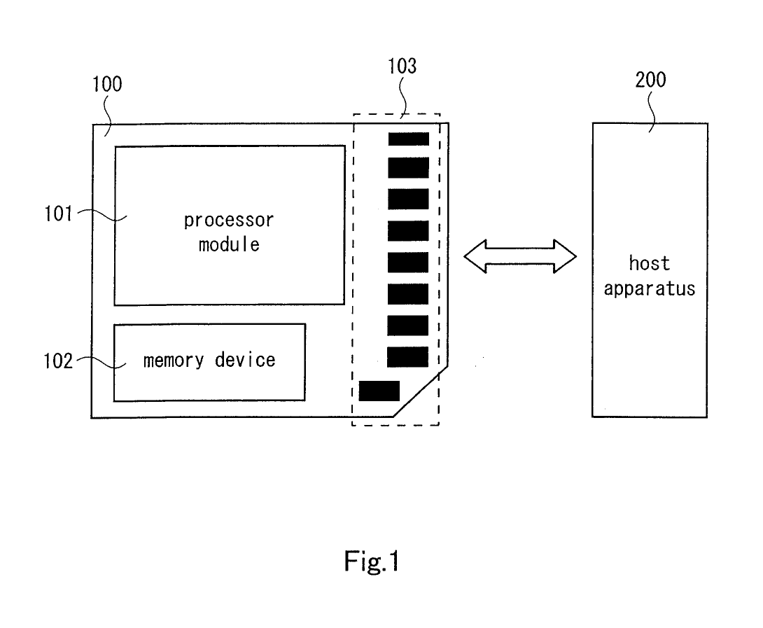

FIG. 1 illustrates a schematic view of a semiconductor memory card (hereinafter, referred to as the memory card) 100 in accordance with the embodiment of the present invention. The appearance of the memory card 100 is similar to the form of a card, such as SD™ memory card which has nine terminals. The memory card 100 is utilized as an external storage media to the host apparatus 200. The host apparatus 200 is, concretely, a kind of electronic system, like a personal computer, PDA, digital still camera, or cellular phone dealing with many kinds of data, such as picture data, music data, or ID data.

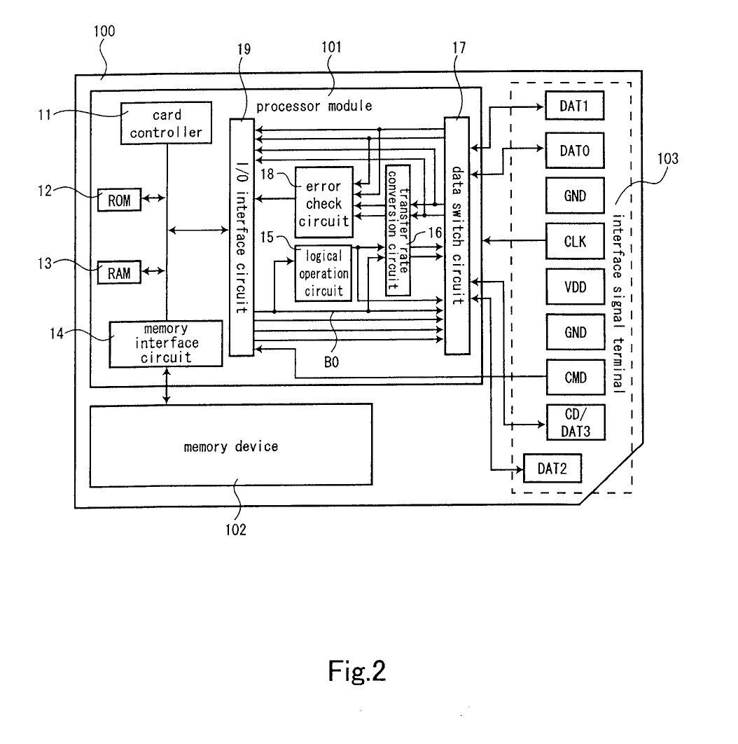

The memory card 100 comprises the processor module 101 as an internal circuit controlling various operation described below, the memory device 102 as data storage region, and the interface signal terminals 103 to transmit (receive) a signal to (from) the host apparatus 200. The internal structure of the memory card 100 is described with reference to FIG. 2 illustrates a block diagram showing the internal structure on the memory card 100 in accordance with the embodiment of the present invention.

The processor module 101 comprises card controller 11, ROM (Read Only Memory) 12, RAM (Random Access Memory) 13, memory interface circuit 14, logical operation circuit 15, transfer rate conversion circuit 16, data switch circuit 17, error check circuit 18, and I/O interface circuit 19, as shown in FIG. 2. The card controller 11 is the main controller of the memory card 100. The ROM 12 stores a control program which is used in card controller 11. RAM 13 is used as work-buffer memory to card controller 11. Memory interface circuit 14 is an interface circuit for memory device 102.

The logical operation circuit 15, the data conversion circuit 16, the data switch circuit 17, and the error check circuit 18 are treated more fully below. At least one of the functions of the logical operation circuit 15, the transfer rate conversion circuit 16, the data switch circuit 17, and the error check circuit 18 may be realized as software executed on the processor module 101.

The memory device 102 is a non-volatile memory, such as a NAND type flash EEPROM. The memory device 102 stores many kinds of data transmitted from the host apparatus 200.

The interface signal terminals 103 comprises nine terminals, i.e., the CLK terminal, the CMD terminal, the DAT0, DAT1, DAT2, and DAT3 terminals, the VDD terminal, and the two GND terminals. The CLK terminal is used for receiving a clock signal which is transmitted from the host apparatus 200 to the memory card 100. The CMD terminal is used for receiving a command and transmitting a response corresponding to the command. The DAT0, DAT1, DAT2, and DAT3 terminals are used for receiving write-data and transmitting read-data. The VDD terminal is used for supplying a power voltage. The two GND terminals are used for supplying a ground voltage.

The memory card 100 operates in two data transfer modes, that is, the 4 bits bus mode (the first operation mode), and the 1 bit bus mode (the second operation mode). In the 4 bits bus mode, the memory card 100 uses the DAT0, DAT1, DAT2, and DAT3 terminals, and transmits data with 4 bits bus width. In the 1 bit bus mode, the memory card 100 uses one of the data terminals, such as the DAT0 terminal, and transmits data with 1 bit bus width.

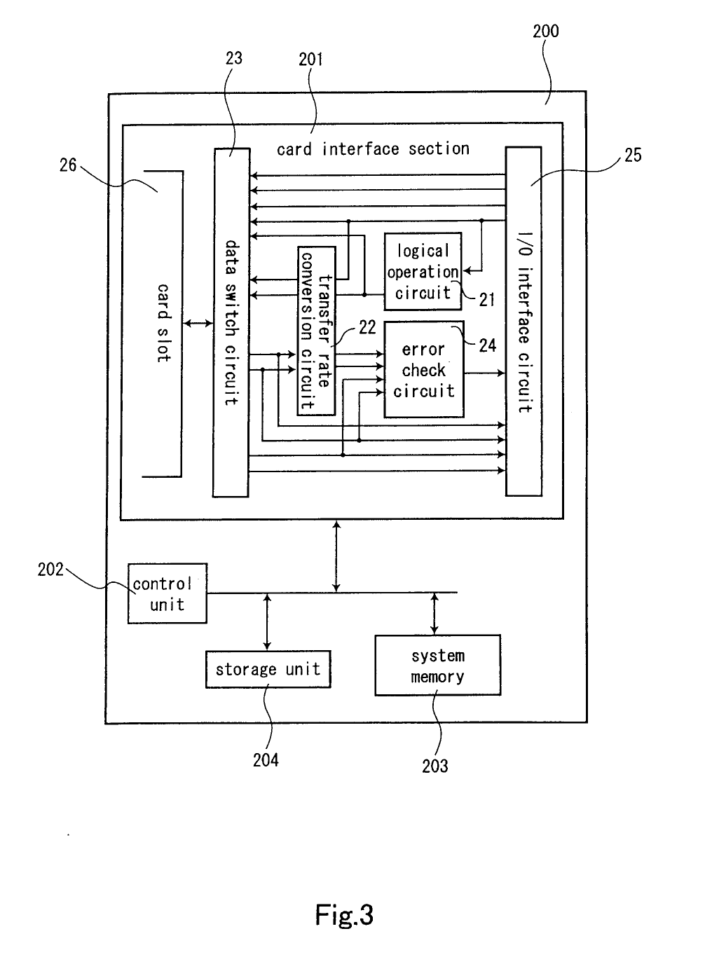

The internal structure of the host apparatus 200 is described with reference to FIG. 3 illustrates a block diagram showing the internal structure of the host apparatus 200 in accordance with the embodiment of the present invention. The host apparatus 200 comprises the card interface section 201 to which the memory card 100 can be attached and from which the attached memory card 100 can be removed, the control unit 202 which is the main control circuit of the host apparatus 200, the system memory 203 which is constituted from, e.g., a RAM, and the storage unit 204 which is constituted from, e.g., hard disk drive units.

The card interface section 201 comprises the card slot 26 in which the memory card 100 can be inserted, the logical operation circuit 21, the transfer rate conversion circuit 22, the data switch circuit 23, the error check circuit 24, and I/O interface circuit 25 which has a function of an interface with these four control circuits.

The logical operation circuit 21, the transfer rate conversion circuit 22, the data switch circuit 23, and the error check circuit 24 have substantially the same function as the above-mentioned four control circuits of the same name included in the memory card 100. The card slot 26 comprises interface signal terminals corresponding to the nine interface signal terminals 103 included in the memory card 100.

A detailed function of each of the control circuits, i.e., the logical operation circuits 15 and 21, the transfer rate conversion circuits 16 and 22, the data switch circuits 17 and 23, the error check circuits 18 and 24 included in the memory card 100 and the host apparatus 200 is described below. As explained above, since the functions of the four above-mentioned control circuits is substantially the same or similar in the memory card 100 and the host apparatus 200, the following is explained as to the memory card 100.

The logical operation circuit 15 executes a logical operation on a signal on the bus B0 coupled with the DAT0 terminal (the first signal), and outputs a signal generated by the logical operation (the second signal), while the memory card 100 is operating in the 1 bit bus mode. The logical operation circuit 15 may be a programmable device which is constituted from a plurality of gate circuits combined with an AND gate, an OR gate and so on, and it may be possible to change the combination of the gate circuits with a command from the host apparatus 200.

In the present embodiment, a logic reversal is assumed as the logical operation executed in the logical operation circuit 15. Thereby, a differential data transfer becomes possible with the signal on the bus B0 (the first signal) and its logic reversal signal (the second signal). In addition, the logical operation may not be limited to the logic reversal, and may be suitably programmed.

The transfer rate conversion circuit 16 converts a transfer rate of the signal on the bus B0 coupled with the DAT0 terminal (the first signal) into a different transfer rate and outputs a signal generated by the conversion of the transfer rate (the third signal), while the memory card 100 is operating in the 1 bit bus mode. The transfer rate conversion circuit 16 also converts a transfer rate of the second signal into a different transfer rate and outputs a signal generated by the conversion of the transfer rate (the fourth signal), while the memory card 100 is operating in the 1 bit bus mode.

In the present embodiment, the transfer rate conversion circuit 16 outputs the signal with half the transfer rate of the original transfer rate. However, the conversion of the transfer rate may not be limited to one half. For example, the transfer rate conversion circuit 16 may output the signal with the original transfer rate without converting the transfer rate, or may output the signal with double the transfer rate of the original transfer rate.

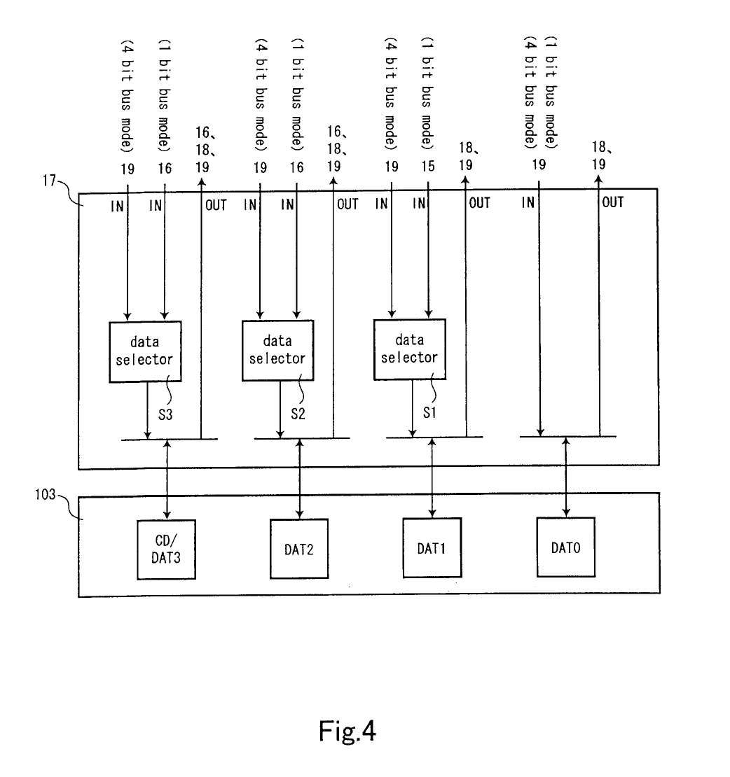

The data switch circuit 17 selects the signal transmitted to the DAT0, DAT1, DAT2, and DAT3 terminals according to switching the 4 bit bus mode to the 1 bit bus mode, or switching the 1 bit bus mode to the 4 bits bus mode. FIG. 4 illustrates a block diagram showing the internal structure of the data switch circuit 17 in accordance with the embodiment of the present invention. Except for the bus B0 coupled with the DAT0 terminal, the data selectors S1, S2, and S3 for transmitting the signal generated in the logical operation circuit 15 (the second signal) and the signals generated in the transfer rate conversion circuit 16 (the third signal and the fourth signal) are configured.

The data selector circuit S1 selects either the logic reversal signal (the second signal) generated by inputting the first signal into the logical operation circuit 15 in the 1 bit bus mode or the signal in the 4 bits bus mode, and the selected signal transmitted to the DAT1 terminal.

The data selector circuit S2 selects either the signal converted into half the transfer rate (the third signal) generated by inputting the first signal into the transfer rate conversion circuit 16 in the 1 bit bus mode or the signal in the 4 bits bus mode, and the selected signal transmitted to the DAT2 terminal.

The data selector circuit S3 selects either the logic reversal signal of half the transfer rate (the fourth signal) generated by inputting the first signal into the logical operation circuit 15 and the transfer rate conversion circuit 16 in the 1 bit bus mode or the signal in the 4 bits bus mode, and the selected signal transmitted to the DAT3 terminal.

In the present embodiment, the data transfer between the memory card 100 and the host apparatus 200 in the 1 bit bus mode is executed in two routes. The first route is the data transfer by a differential signal collectively using the pair of signals transmitted to the DAT0 and DAT1 terminals. The second route is the data transfer by a differential signal collectively using the pair of signals transmitted to the DAT2 and DAT3 terminals. The transfer rate of the second route is half the transfer rate of the first route.

The error check circuit 18 is operates when the write-data is inputted to the memory card 100 from the host apparatus 200 in the 1 bit bus mode, and checks whether the write-data is correctly received. The error check circuit 18 checks an error of the write-data by comparing the data inputted from the DAT0 terminal and the data inputted from the DAT1 terminal, or the data inputted from the DAT2 terminal and the data inputted from the DAT3 terminal when the write-data is inputted to the memory card 100 from the host apparatus 200 in the 1 bit bus mode.

The signals inputted to the DAT1 to DAT3 terminals from the host apparatus 200 are generated by the logical operation circuit 21 and the transfer rate conversion circuit 22 in the host apparatus 200 same as or similar to the logical operation circuit 15 and the transfer rate conversion circuit 16 in the memory card 100 described above.

The error check circuit 18 executes the same or similar logical operation on the signal inputted from the DAT0 terminal as a logical operation which have been executed to the signal inputted from the DAT1 terminal by the logical operation circuit 21 in the host apparatus 200, and compares the signal inputted from the DAT1 terminal and the signal generated by the logical operation. A comparison result in the first route is fed to the card controller 11.

After converting the transfer rate of the signals inputted from the DAT2 and DAT3 terminals into the same transfer rate as the transfer rate of the signal inputted from the DAT0 terminal in the transfer rate conversion circuit 17, the error check circuit 18 also executes the same or similar logical operation on the signal inputted from the DAT2 terminal as a logical operation which has been executed to the signal inputted from the DAT3 terminal by the logical operation circuit 21 in the host apparatus 200, and compares the signal inputted from the DAT3 terminal and the signal generated by the logical operation. A comparison result in the second route is fed to the card controller 11.

The card controller 11 receives the comparison results from the error check circuit 18, and cancels data inputted from the one route in which an error was detected during the data transfer, and acquires data inputted from the other route in which an error has not been detected.

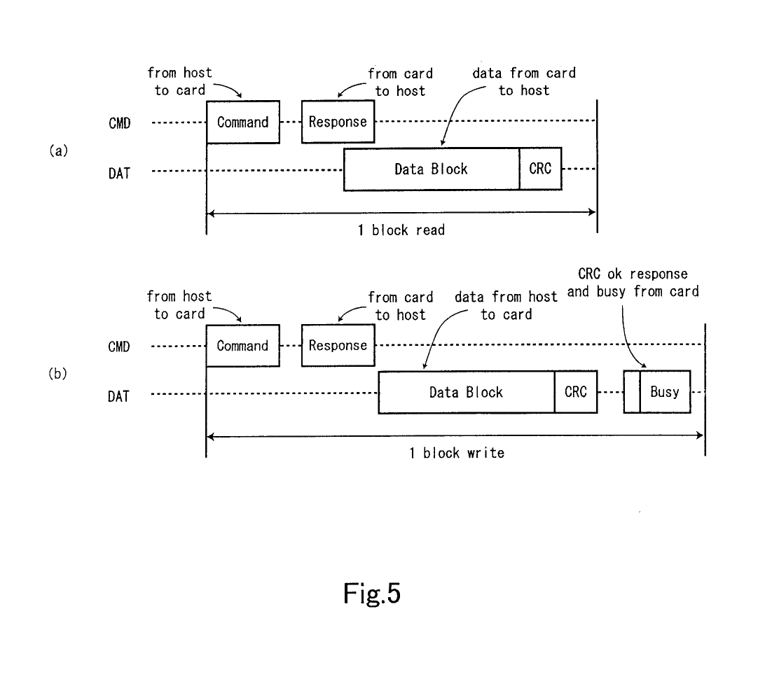

The format of the read-data outputted from the memory card 100 and the write-data inputted to the memory card 100 is described with reference to FIGS. 5 to 7.

As the access operation to the memory card 100, a single read operation, a multiple read operation, a single write operation, and a multiple write operation may be considered. The difference between the single read (write) operation and the multiple read (write) operation is steps of a command to input and whether to execute the 1 block read (write) or to execute the multiple blocks read (write).

FIGS. 5(a) and 5(b) illustrate a timing chart of the signals inputted to or outputted from the CMD terminal and the DAT terminal in the memory card 100 at the time of the single read operation and the single write operation in accordance with the embodiment of the present invention.

FIG. 5 (a) describes the single read operation. A read command is inputted to the memory card 100 from the host apparatus 200 using the CMD terminal. The memory card 100 receives the read command and outputs a response to the host apparatus 200 using the CMD terminal. The memory card 100 outputs the 1 block read-data transmitted from the memory device 102 with CRC bits added to the read-data using the DAT terminal. The CRC (Cyclic Redundancy Check) bits are generated by the CRC circuit (not illustrated) included in the processor module 101.

FIG. 5 (b) describes the single write operation. A write command is inputted to the memory card 100 from the host apparatus 200 using the CMD terminal. The memory card 100 receives the write command and outputs a response to the host apparatus 200 using the CMD terminal. The memory card 100 receives the 1 block write-data outputted from the host apparatus 200 with CRC bits added to the write-data using the DAT terminal, and returns a response corresponding to the CRC bits and Busy to the host apparatus 200, the write of the data to the memory device 102. The CRC bits are generated by the CRC circuit (not illustrated) included in the card interface section 201.

Hereinafter, the detailed operation is described on the assumption that the memory card 100 executes the single read (write) operation. In addition, the present embodiment may be applicable to the multiple read (write) operation. In the above-mentioned single read and single write operation, the data format is the same or similar.

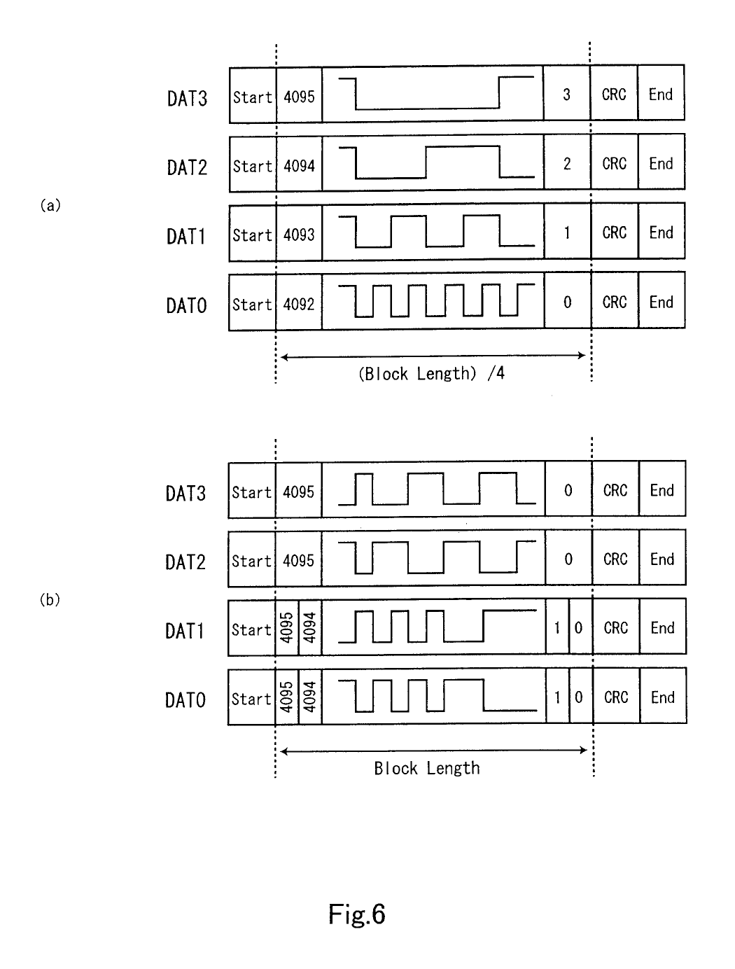

FIGS. 6(a) and 6(b) illustrate a schematic view of a data format in the 4 bits bus mode and 1 bit bus mode in accordance with the embodiment of the present invention. The format of the data outputted from or inputted to each DAT terminal is [Start Bit]+[Data Bits]+[CRC Bits]+[End Bit], and the same is said for the 4 bits bus mode and the 1 bit bus mode.

The single read operation is described with reference to FIG. 6 (a). In the single read operation, the memory card 100 executes a read of the 1 block unit, such as 4096 bits. When executing the single read operation in the 4 bits bus mode, the memory card 100 outputs the read-data with 4 bits bus width using the DAT0 to DAT3 terminals by dividing the read-data of the 1 block unit from a MSB (Most Significant Bit) side to four signals in which [Start Bit] is allocated at the head, as shown in FIG. 6 (a).

On the other hand, when executing the single read operation in the 1 bit bus mode, the memory card 100 outputs the read-data with 1 bit bus width using the DAT0 terminal by transmitting all the read-data of the 1 block unit from the MSB side with [Start Bit] at the a head. The memory card 100 also outputs the logic reversal signal from the vacant DAT1 terminal which is generated by inputting the signal on the bus B0 coupled with the DAT0 terminal into the logical operation circuit 15, as shown in FIG. 6 (b).

The memory card 100 also outputs the signal converted into half the transfer rate from the vacant DAT2 terminal which is generated by inputting the signal on the bus B0 coupled with the DAT0 terminal into the transfer rate conversion circuit 16, and outputs the logic reversal signal of half the transfer rate from the vacant DAT3 terminal which is generated by inputting the signal on the bus B0 coupled with the DAT0 terminal into the logical operation circuit 15 and the transfer rate conversion circuit 16.

The single write operation is described with reference to FIG. 6 (b). In the single write operation, the memory card 100 executes a write of the 1 block unit, such as 4096 bits. When executing the single write operation in the 4 bits bus mode the host apparatus 200 inputs the write-data with 4 bits bus width using the DAT0 to DAT3 terminals by dividing the write-data of the 1 block unit from a MSB side to four signals in which [Start Bit] is allocated at the head, as shown in FIG. 6(a).

On the other hand, when executing the single write operation in the 1 bit bus mode, the host apparatus 200 inputs the write-data with 1 bit bus width using the DAT0 terminal by transmitting all the write-data of the 1 block unit from the MSB side with [Start Bit] at the head. The host apparatus 200 also inputs the logic reversal signal to the vacant DAT1 terminal which is generated by inputting the signal on the bus coupled with the DAT0 terminal into the logical operation circuit 21, as shown in FIG. 6 (b).

The host apparatus 200 also inputs the signal converted into half the transfer rate to the vacant DAT2 terminal which is generated by inputting the signal on the bus coupled with the DAT0 terminal into the transfer rate conversion circuit 22, and inputs the logic reversal signal of half the transfer rate to the vacant DAT3 terminal which is generated by inputting the signal on the bus coupled with the DAT0 terminal into the logical operation circuit 21 and the transfer rate conversion circuit 22.

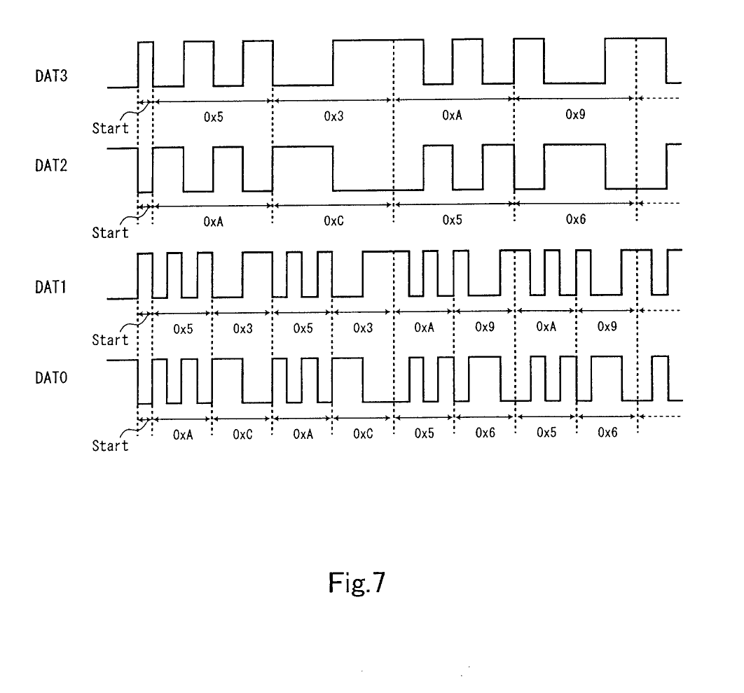

The data format in the single read operation is described in detail with reference to FIG. 7 illustrates a waveform chart of data buses through which the signals are transmitted to the DAT0 to DAT3 terminals in the 1 bit bus mode under the condition that the read-data is “0xAC56 . . . ” in accordance with the embodiment of the present invention. However, the suffix “0x” means a hexadecimal notation. FIG. 7 shows several bytes expanded from the head of the signals.

The transfer rate of the first route collectively using the pair of signals transmitted to the DAT0 and DAT1 terminals is faster than the transfer rate of the second route collectively using the pair of signals transmitted to the DAT2 and DAT3 terminals. For this reason, in order to make the end of transmission of the read-data with the 1 block unit have the same timing in the first route and the second route, the same data is transmitted again per 8 bits to the DAT0 and DAT1 terminals, as shown in FIG. 7

The host apparatus 200 may check whether these data inputted from the two routes were correctly received or not by comparing using the error check circuit 24. When the data was not received correctly, the host apparatus 200 may require a retry of the data transfer by outputting an error status flag. Since the waveform in the single write operation is the same or similar to that in the single read operation, the other explanation is omitted.

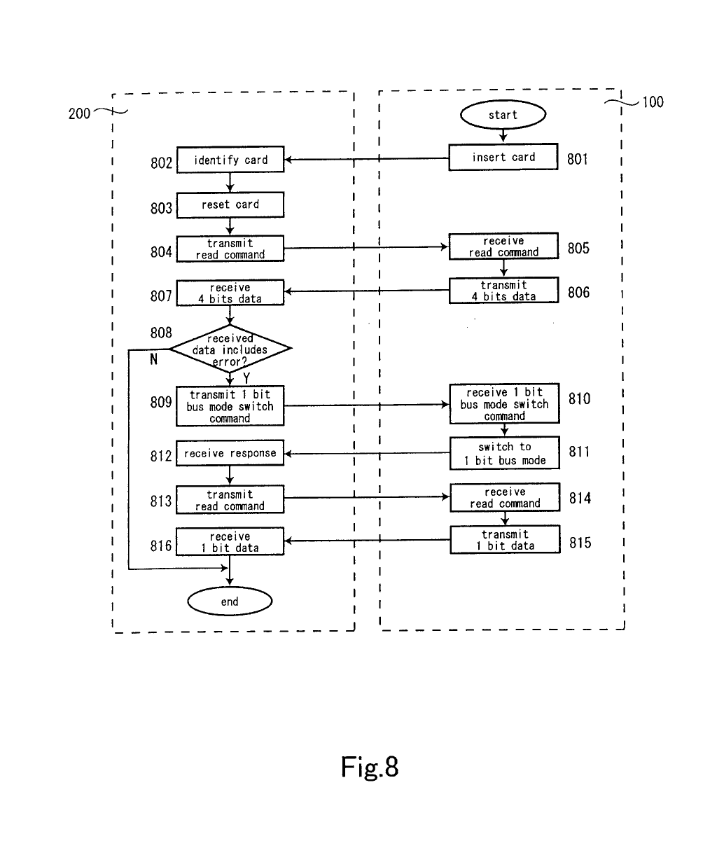

The operation of the memory card 100 concerning the present embodiment is described with reference to FIG. 8 illustrates a flowchart which shows the single read operation on the memory card 100 in accordance with the embodiment of the present invention. Hereinafter, the operation that in case an error is detected in the read-data during the single read operation in the 4 bits bus mode, the operation mode switches to the 1 bit bus mode is described.

The memory card 100 is inserted to the card slot 26 in the host apparatus 200 on condition that the host apparatus 200 is supplied with a power voltage (Step 801). The power voltage is supplied to the memory card 100, and the host apparatus 200 identifies the insertion of the memory card 100 (Step 802). In order to set the memory card 100 as accessible, the memory card 100 is initialized (Step 803), and an access from the host apparatus 200 is permitted.

The host apparatus 200 transmits a read command in order to read the data stored in the memory device 102 in the memory card 100 (Step 804). The memory card 100 receives the read command (Step 805), and transmits the data to the host apparatus 200 in the 4 bits bus mode (Step 806). The host apparatus 200 receives the data from the memory card 100 (Step 807), and checks the CRC bits added to the received data (Step 808).

In case an error is detected in the received data, the host apparatus 200 transmits a 1 bit bus mode switch command which switches the 4 bits bus mode to the 1 bit bus mode (Step 809). The memory card 100 receives the 1 bit bus mode switch command (Step 810), and switches the 4 bits bus mode to the 1 bit bus mode (Step 811). The memory card 100 returns a response to the host apparatus 200, and the host apparatus 200 receives the response (Step 812).

The host apparatus 200 transmits a read command again (Step 813). The memory card 100 receives the read command (Step 814). The memory card 100 transmits the data from the DAT0 terminal in the 1 bit bus mode, and also transmits the logic reversal signal from the vacant DAT1 terminal which is generated by inputting the signal on the bus B0 coupled with the DAT0 terminal into the logical operation circuit 15.

The memory card 100 also transmits the signal converted into half the transfer rate from the vacant DAT2 terminal which is generated by inputting the signal on the bus B0 coupled with the DAT0 terminal into the transfer rate conversion circuit 16, and transmits the logic reversal signal at half the transfer rate from the vacant DAT3 terminal which is generated by inputting the signal on the bus B0 coupled with the DAT0 terminal into the logical operation circuit 15 and the transfer rate conversion circuit 16 (Step 815).

The host apparatus 200 receives the data transmitted from the memory card 100 in the 1 bit bus mode, and executes the comparison in the error check circuit 24. The host apparatus 200 cancels the data inputted from the one route in which an error has detected, and acquires the data inputted from the other route in which an error has not been detected (Step 816).

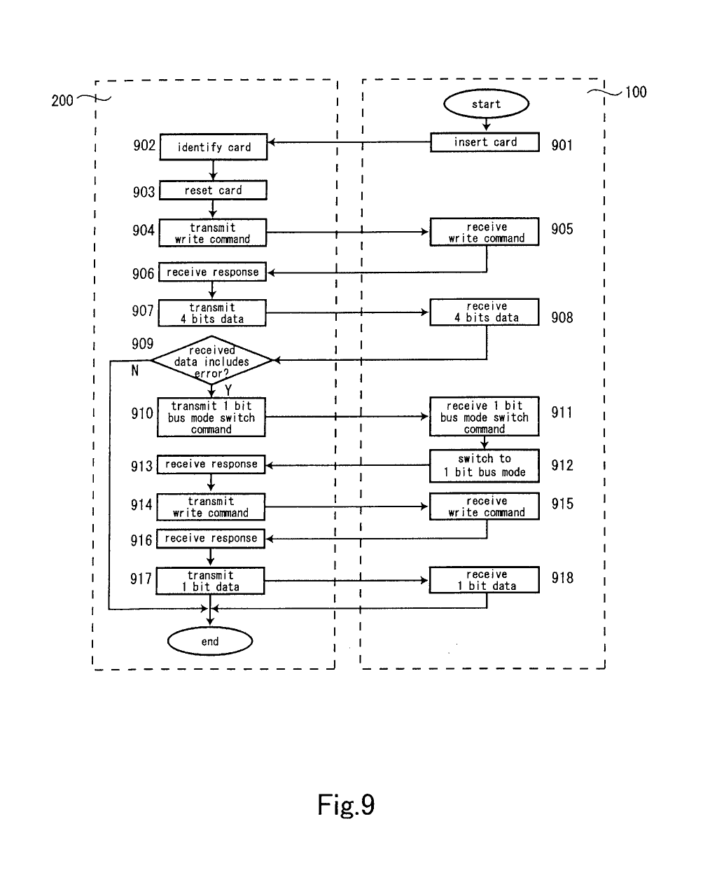

FIG. 9 illustrates a flowchart which shows the single write operation on the memory card 100 in accordance with the embodiment of the present invention. Hereinafter, the operation that in case an error is detected in the write-data during the single write operation in the 4 bits bus mode, the operation mode switches to the 1 bit bus mode is described.

The memory card 100 is inserted to the card slot 26 in the host apparatus 200 on condition that the host apparatus 200 is supplied with a power voltage (Step 901). The power voltage is supplied to the memory card 100, and the host apparatus 200 identifies the insertion of the memory card 100 (Step 902). In order to set the memory card 100 as accessible, the memory card 100 is initialized (Step 903), and an access from the host apparatus 200 is permitted.

The host apparatus 200 transmits a write command in order to store the data in the memory device 102 in the memory card 100 (Step 904). The memory card 100 receives the write command (Step 905), and returns a response to the host apparatus 200. The host apparatus 200 receives the response from the memory card 100 (Step 906), and transmits the data to the memory card 100 in the 4 bits bus mode (Step 907).

The memory card 100 receives the data from the host apparatus 200 (Step 908), and checks the CRC bits added to the received data. The memory card 100 returns a response to the host apparatus 200 (Step 909). If an error is detected in the transmitted data, the host apparatus 200 transmits a 1 bit bus mode switch command which switches the 4 bits bus mode to the 1 bit bus mode (Step 910).

The memory card 100 receives the 1 bit bus mode switch command (Step 911), and switches the 4 bits bus mode to the 1 bit bus mode (Step 912). The memory card 100 returns a response to the host apparatus 200, and the host apparatus 200 receives the response (Step 913).

The host apparatus 200 transmits a write command again (Step 914).

The memory card 100 receives the write command (Step 915), and returns a response to the host apparatus 200. The host apparatus 200 receives the response (Step 916), and transmits the data to the DAT0 terminal in the 1 bit bus mode, and also transmits the logic reversal signal to the vacant DAT1 terminal which is generated by inputting the signal on the bus coupled with the DAT0 terminal into the logical operation circuit 21.

The host apparatus 200 also transmits the signal converted into half the transfer rate to the vacant DAT2 terminal which is generated by inputting the signal on the bus coupled with the DAT0 terminal into the transfer rate conversion circuit 22, and transmits the logic reversal signal of half the transfer rate to the vacant DAT3 terminal which is generated by inputting the signal on the bus coupled with the DAT0 terminal into the logical operation circuit 21 and the transfer rate conversion circuit 22 (Step 917).

The memory card 100 receives the data transmitted from the host apparatus 200 in the 1 bit bus mode, and executes the comparison in the error check circuit 18. The comparison result is fed to the card controller 11 in the processor module 101. The card controller 11 cancels the data inputted from the one route in which an error has detected, and acquires the data inputted from the other route in which an error has not been detected (Step 918). The card controller 11 executes the write to the memory device 102.

By executing the above-mentioned operation flow, the data transfer mode between the memory card 100 and the host apparatus 200 is switched automatically according to the situation of noise without switching by a user, and the memory card 100 transmits or receives the data correctly.

Moreover, a user may switch the 4 bits bus mode and the 1 bit bus mode with a command from the host apparatus 200, and may communicate using one of the modes.

Moreover, although it was explained that the data transfer mode when the memory card 100 has been booted is the 4 bits bus mode, the data transfer mode when the memory card 100 has been booted may be the 1 bit bus mode.

Moreover, in the case where the memory card 100 supports the 1 bit bus mode, the memory card 100 may transmit the response which represents support of the 1 bit bus mode to the host apparatus 200, and the host apparatus 200 may set the data transfer mode corresponding to the response.

As mentioned above, in the case where an error is detected in the 4 bits bus mode, the memory card 100 in accordance with the embodiment of the present invention switches the 4 bits bus mode to the 1 bit bus mode. The memory card 100 transmits the data from the DAT0 terminal, and also transmits the logic reversal signal from the vacant DAT1 terminal which is generated by inputting the signal on the bus B0 coupled with the DAT0 terminal into the logical operation circuit 15.

The memory card 100 also transmits the signal converted into half the transfer rate from the vacant DAT2 terminal which is generated by inputting the signal on the bus B0 coupled with the DAT0 terminal into the transfer rate conversion circuit 16, and transmits the logic reversal signal of half the transfer rate from the vacant DAT3 terminal which is generated by inputting the signal on the bus B0 coupled with the DAT0 terminal into the logical operation circuit 15 and the transfer rate conversion circuit 16

By generating the logic reversal signal in the logical operation circuit 15, the memory card 100 transmits data correctly with the differential signal collectively using the pair of signals transmitted to the DAT0 and DAT1 terminals (the first route). The memory card 100 also transmits data correctly with the differential signal collectively using the pair of signals transmitted to the DAT2 and DAT3 terminals (the second route).

The data transfer with the differential signal has a relatively high reliability against noise in the case where the speed of the data transfer is increased and the operating voltage is lowered. In addition, the data transfer with the differential signal converted into half the transfer rate of the original transfer rate in the second route relatively reduces an influence of noise.

Moreover, the memory card 100 uses the vacant DAT terminals effectively in the 1 bit bus mode, thus, the memory card 100 realizes reliable data transfer against the noise, without changing the number of pins (terminals) of the conventional SD™ memory card.

Moreover, an assignment of the data transmitted to the DAT0 to DAT3 terminals in the 1 bit bus mode is not limited to the assignment of the above-mentioned embodiment, and may be suitably assigned in consideration of the wiring arrangement inside the memory card 100 and so on.

Moreover, in the embodiment of the present invention, although the memory card 100 transmits the same data again per 8 bits to the DAT0 and DAT1 terminals in order to make the end of transmission of the data have the same timing in the first route (the pair of the DAT0 and DAT1 terminals) and the second route (the pair of the DAT0 and DAT1 terminals), the memory card 100 may not execute this second transmission of the data.

Moreover, in the embodiment of the present invention, although the data transfer in the 1 bit bus mode is executed in the first route which consists of the pair of the DAT0 and DAT1 terminals and in the second route which consists of the pair of the DAT2 and DAT3 terminals, the memory card 100 may execute the data transfer in either the first route or the second route.

Moreover, in the 1 bit bus mode, the memory card 100 may check whether an error is detected or not in the data transfer using the pair of the DAT0 and DAT1 terminals when the data transfer with the 1 block using the pair of the DAT2 and DAT3 terminals has been completed.

If an error is not detected, the memory card 100 may not execute the data transfer using the pair of the DAT2 and DAT3 terminals, and may transmit the differential signal at the original transfer rate using only the pair of the DAT0 and DAT1 terminals.

On the other hand, if an error is detected, the memory card 100 may not execute the data transfer using the pair of the DAT0 and DAT1 terminals, and may transmit the differential signal at half the original transfer rate using only the pair of the DAT2 and DAT3 terminals.

Moreover, in the embodiment of the present invention, although the appearance of the memory card 100 is similar to the form of the SD™ memory card having the nine terminals, the number of terminals may not be limited to nine, and the number of data terminals may not be limited to four.

Moreover, in the embodiment of the present invention, although the memory card 100 transmits the signal with the 1 bit bus width in the second operation mode, the transfer bit width in the second operation mode may not limited to the 1 bit. For example, the memory card 100 may transmit the signal with the 2 bits bus width using the two data transfer terminals, and may transmit the logic reversal signal of them using the two vacant data transfer terminals. The memory card 100 may execute the data transfer by the differential signal collectively using the signal with the 2 bits bus width and the logic reversal signal of them.

Moreover, the transfer clock frequency in the 1 bit bus mode may be higher than the transfer clock frequency in the 4 bits bus mode.

Moreover, the embodiment of the present invention may be applied to the data transfer system which comprises the memory card 100 having the nine interface signal terminals 103 and the host apparatus 200 to which the memory card 100 can be attached. The memory card 100 includes the processor module 101 operating in the first operation mode and the second operation mode according to a command from the host apparatus 200. In the first operation mode, the processor module 101 transmits a signal to the DAT0 to DAT3 terminals with the 4 bits bus width, and in the second operation mode, the processor module 101 transmits a first signal to the DAT0 terminal with the 1 bit bus width and transmits a second signal to the DAT1 terminal. The second signal is generated by executing a logical operation on the first signal.

Moreover, the embodiment of the present invention may be applied to a semiconductor memory system. The semiconductor memory system may be such as a surface mount type device and so on, and may be mounted in a cellular phone etc. The semiconductor memory system may be a MCP (Multi Chip Package) with SD™ memory card interface.

What is claimed is:

1. A semiconductor memory card which can be attached to a host apparatus and can be removed from said host apparatus comprising:
a plurality of data transfer terminals; and
an internal circuit configured to transmit a first signal to at least one first data transfer terminal comprising at least one of said data transfer terminals and transmit a second signal to at least one second data transfer terminal comprising at least one of said data transfer terminals different from said at least one first data transfer terminal,
wherein said second signal is generated by executing a logical operation on said first signal.

2. The semiconductor memory card according to claim 1, wherein:
said internal circuit is configured to operate in a first mode and a second mode;
in said first operation mode, said internal circuit transmits a signal to said data transfer terminals with a first bus width more than two bits; and
in said second operation mode, said internal circuit transmits said first signal to said first data transfer terminals with a second bus width less than said first bus width and transmits said second signal to said second data transfer terminals.

3. The semiconductor memory card according to claim 2, wherein in said second operation mode, said internal circuit transmits said first signal to third data transfer terminals different from said first and second data transfer terminals, and transmits said second signal to fourth data transfer terminals different from said first, second, and third data transfer terminals.

4. The semiconductor memory card according to claim 2, wherein in said second operation mode, said internal circuit transmits a third signal to third data transfer terminals different from said first and second data transfer terminals, and transmits a fourth signal to fourth data transfer terminals different from said first, second, and third data transfer terminals, said third signal being generated by changing a transfer rate of said first signal and said fourth signal being generated by changing a transfer rate of said second signal.

5. The semiconductor memory card according to claim 4, said internal circuit further comprising:
a data switch circuit selecting said signal in said first operation mode and said first, second, third, and fourth signals in said second operation mode;
a logical operation circuit generating said second and fourth signals by executing said logical operation on said first and third signal; and
a transfer rate conversion circuit generating said third and fourth signal by changing a transfer rate of said first and third signal.

6. The semiconductor memory card according to claim 5, wherein said logical operation circuit is a programmable device in which a combination of gate circuits can be changed by a command from said host apparatus.

7. The semiconductor memory card according to claim 2, wherein in said second operation mode, said logical operation is logic reversal, and said internal circuit executes a differential data transfer collectively using said first signal and said second signal.

8. The semiconductor memory card according to claim 2, wherein in said second operation mode, said first data transfer terminals consist of one of said data transfer terminals, and said second bus width is one bit.

9. The semiconductor memory card according to claim 2, wherein said internal circuit is configured to transmit a response to said host apparatus and receive a command corresponding to said response from said host apparatus, said command setting either said first operation mode or said second operation mode.

10. A method for controlling a semiconductor memory card which includes a plurality of data transfer terminals comprising:
setting either a first operation mode or a second operation mode according to a command from a host apparatus;
transmitting a signal to said data transfer terminals with a first bus width more than two bits in said first operation mode;
transmitting a first signal to at least one first data transfer terminal comprising at least one of said data transfer terminals with a second bus width less than said first bus width and transmitting a second signal to at least one second data transfer terminal comprising at least one of said data transfer terminals different from said at least one first data transfer terminal in said second operation mode; and
generating said second signal by executing a logical operation on said first signal.

11. The method for controlling the semiconductor memory card according to claim 10, further comprising:
transmitting said first signal to third data transfer terminals different from said first and second data transfer terminals; and
transmitting said second signal to fourth data transfer terminals different from said first, second, and third data transfer terminals in said second operation mode.

12. The method for controlling the semiconductor memory card according to claim 10, further comprising:
transmitting a third signal to third data transfer terminals different from said first and second data transfer terminals;
transmitting a fourth signal to fourth data transfer terminals different from said first, second, and third data transfer terminals in second operation mode; and
generating said third signal by changing a transfer rate of said first signal and generating said fourth signal by changing a transfer rate of said second signal.

13. The method for controlling the semiconductor memory card according to claim 12, further comprising:
selecting said signal in said first operation mode and said first, second, third, and fourth signals in said second operation mode.

14. The method for controlling the semiconductor memory card according to claim 10, further comprising:
changing said logical operation by a command from said host apparatus.

15. The method for controlling the semiconductor memory card according to claim 10, wherein in said second operation mode, said logical operation is logic reversal, said method comprising executing a differential data transfer collectively using said first signal and said second signal.

16. The method for controlling the semiconductor memory card according to claim 10, wherein in said second operation mode, said at least one first data transfer terminal consists of one data transfer terminal, and said second bus width is one bit.

17. The method for controlling the semiconductor memory card according to claim 10, further comprising:
transmitting a response to said host apparatus and receiving said command corresponding to said response from said host apparatus.

18. A semiconductor memory system comprising:
a plurality of data transfer terminals;
a memory device storing data inputted from said data transfer terminals; and
an internal circuit operating in a first operation mode and a second operation mode,
wherein in said first operation mode, said internal circuit transmits a signal to said data transfer terminals with a first bus width more than two bits, and in said second operation mode, said internal circuit transmits a first signal to at least one first data transfer terminal comprising at least one of said data transfer terminals with a second bus width less than said first bus width and transmits a second signal to at least one second data transfer terminal comprising at least one of said data transfer terminals different from said first data transfer terminals, said second signal being generated by executing a logical operation on said first signal.

19. The semiconductor memory system according to claim 18, wherein:
in said second operation mode, said internal circuit transmits a third signal to third data transfer terminals different from said first and second data transfer terminals, and transmits a fourth signal to fourth data transfer terminals different from said first, second, and third data transfer terminals, said third signal is generated by changing a transfer rate of said first signal, and said fourth signal is generated by changing a transfer rate of said second signal.

20. The semiconductor memory system according to claim 18, said internal circuit further comprising:
a data switch circuit selecting said signal in said first operation mode and said first, second, third, and fourth signals in said second operation mode;
a logical operation circuit generating said second and fourth signal by executing said logical operation on said first signal and said third signal; and
a transfer rate conversion circuit generating said third signal and said fourth signal by changing a transfer rate of said first signal and said third signal.

21. A method of operating a semiconductor memory system, comprising:
transmitting first data of a bus width greater than 1 between said system and a host;
determining whether an error exists in said first data;
if an error exists, transmitting a command to said system to operate in a 1-bit bus mode; and
transmitting said first data in said 1-bit bus mode.

22. The method of operating a semiconductor memory system according to claim 21, wherein transmitting said first data in said 1-bit bus mode comprises:
transmitting said first data using a first terminal of said system; and
performing a logical operation on said first data to produce second data; and
transmitting said second data on a second terminal of said system.

23. The method of operating a semiconductor memory system according to claim 22, comprising:
transmitting said first and second data at the same time.

24. The method of operating a semiconductor memory system according to claim 21, comprising:
producing a third signal by changing a transfer rate of said first signal;
producing a fourth signal by changing a transfer rate of said second signal; and
transmitting said third and fourth signals on third and fourth terminals of said system.

25. The method of operating a semiconductor memory system according to claim 21, comprising:
producing said third signal to have a transfer rate less than a transfer rate of said first signal; and
producing said fourth signal to have a transfer rate less than a transfer rate of said second signal.
